(19) United States
(12) Patent Application Publication
(10) Pub. No.: US 2024/0322919 A1
(43) Pub. Date: Sep. 26, 2024

(54) Method and Device of Antenna Calibration for Radio System

(71) Applicant: Telefonaktiebolaget LM Ericsson (publ), Stockholm (SE)

(72) Inventors: Hao Zhang, Guangzhou (CN); Ang Feng, Solna (SE); Christian Braun, Vallentuna (SE)

(21) Appl. No.: 18/579,529

(22) PCT Filed: Jul. 20, 2021
(86) PCT No.: PCT/CN2021/107361

§ 371 Date: Jan. 16, 2024

(51) Int. Cl. H04B 17/12; H04B 17/21

(52) U.S. Cl. CPC H04B 17/12; H04B 17/221

(57) ABSTRACT

The present disclosure provides a method of antenna calibration for a radio system comprising an antenna system comprising a plurality of antenna elements corresponding to a plurality of radio chains. The method comprising performing first level antenna calibrations at a first time interval and performing second level antenna calibrations in between the first level antenna calibrations at a second time interval, wherein the second level antenna calibrations are based on estimations, and length of the first time interval is of more than one length of second time intervals. The present disclosure also provides a corresponding device, computer programs, and computer-readable storage.

### TECHNICAL FIELD

The present disclosure generally relates to the technical field of radio communication, and particularly, to a method and device of antenna calibration for a radio system.

### BACKGROUND

This section is intended to provide a background to the various embodiments of the technology described in this disclosure. The description in this section may include concepts that could be pursued, but are not necessarily ones that have been previously conceived or pursued. Therefore, unless otherwise indicated herein, what is described in this section is not prior art to the description and/or claims of this disclosure and is not admitted to be prior art by the mere inclusion in this section.

In current Fourth Generation (4G) and in particular Fifth Generation (5G) radio systems, one key attribute is increased capacity in radio networks. Beamforming is one technology that will be used by 5G radio systems to provide the desired increased capacity in an efficient manner. In particular, a 5G radio base station will utilize a large antenna array including tens if not hundreds of antennas, which are also referred to herein as antenna elements. Each antenna element is connected to a radio transceiver path. Applying proper scaling in the transceiver paths enables beamforming by efficient control of spatial coherent additions of desired signals and coherent subtractions of unwanted signals. Such beamforming is used both to enable high antenna gain to a desired User Equipment (UE) as well as to enable parallel communication to several UEs using the same time/frequency resource by using orthogonal spatial communication paths (i.e., by using orthogonal beams).

One issue that arises when implementing a radio base station that utilizes beamforming is that there are variations in gain and phase between different antenna paths (i.e., between different radio transmitter paths and between different radio receiver paths). To enable precise beamforming, full control of vector additions of high frequency radio signals is needed. Hence, accurate control of amplitude and phase are required in every radio chain. In order to achieve the accuracy, an antenna calibration (AC) procedure needs to be applied, in which the phase and amplitude distortion of the radio chains shall be measured and compensated so that the signals are aligned at antenna reference ports where signals start to achieve coherence to achieve a good beamforming performance. This requires the AC function to calibrate all the hardware of the radio chains timely.

### SUMMARY

It is an object of the present disclosure to address one or more of the problems arisen in antenna calibration.

According to a first embodiment of the disclosure, there is provided a method of antenna calibration for a radio system comprising an antenna system comprising a plurality of antenna elements corresponding to a plurality of radio chains. The method comprising performing first level antenna calibrations at a first time interval and second level antenna calibrations in between the first level antenna calibrations at a second time interval, wherein the second level antenna calibrations are based on estimations and length of the first time interval is of more than one length of second time intervals.

Each of the first level antenna calibrations comprises the following steps: performing measurements of full active bandwidth of each radio chain for obtaining radio chain channel state for antenna calibration, calculating first calibration values based on the measurements, and calibrating the antenna system with the first calibration values.

According to a second embodiment of the disclosure, there is provided an apparatus of antenna calibration for a radio system comprising an antenna system comprising a plurality of antenna elements corresponding to a plurality of radio chains, comprising, or comprising all of, but enabling, any one or more of the following components: a first level antenna calibration component configured to perform first level antenna calibrations at a first time interval, and a second level antenna calibration component configured to perform second level antenna calibrations in between the first level antenna calibrations at a second time interval, wherein the second level antenna calibrations are based on estimations, and length of the first time interval is of more than one length of second time intervals. The first level antenna calibration component further comprises a measurement subcomponent, a calculating subcomponent, and a calibrating subcomponent. The measurement subcomponent is configured to perform measurements of full active bandwidth of each radio chain for obtaining radio chain channel state for antenna calibration, the calculating subcomponent is configured to calculate first calibration values based on the measurements, and the calibrating subcomponent is configured to calibrate the antenna system with the first calibration values.

According to a third embodiment of the disclosure, there is provided a device of antenna calibration for a radio system comprising an antenna system comprising a plurality of antenna elements corresponding to a plurality of radio chains. The device comprises a storage, adapted to store instructions therein and a processor, adapted to execute the instructions to cause the device to perform the steps of any of the methods here.

According to a fourth embodiment of the disclosure, there is provided one or more computer-readable storage storing computer-executable instructions thereon, when executed by a computing device, causing the computing device to implement the method of any of any of the methods here.

According to a fifth embodiment of the disclosure, there is provided a device adapted to perform any of the methods here.

According to a sixth embodiment of the disclosure, there is provided a computer program, comprising instructions which, when executed on at least one processor, cause the at least one processor to carry out the method according to any one of the methods here.

According to a seventh embodiment of the disclosure, there is provided a carrier containing the computer program of the eighth embodiment, wherein the carrier is one of an electronic signal, optical signal, radio signal, or computer readable storage.

According to an eighth embodiment of the disclosure, there is provided a radio system. The radio system comprises an antenna system and an apparatus of antenna calibration adapted to perform the method of any of the methods here.

As a whole, according to the present disclosure, a dual level antenna calibration solution is provided. The first level AC at a first time interval is done by AC measurement and the second level AC at a second time interval which is much shorter than the first time interval is done by estimation, therefore, the AC coefficients would be updated in a very short period of the second time interval without extra AC signal injection or occupation of the traffic and thus without much disturbance to the traffic. Thus accuracy of AC can be improved and thus MIMO performance of RBS can be enhanced, and disturbance to traffic can be decreased. As the computation load of each second level AC is much smaller than the first level AC, the computation load of the solution can be decreased.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and details through use of the accompanying drawings.

FIG. 1 illustrates a schematic view of antenna calibration according to a current solution.

FIG. 2 illustrates a schematic view of antenna calibration measurement according to a current solution.

FIG. 3a illustrates an example embodiment of a radio system that applies antenna calibration for an antenna array according to embodiments of the present disclosure.

FIG. 3b illustrates an example of the antenna system of FIG. 3a in accordance with some embodiments of the present disclosure.

FIG. 4 illustrates a schematic view of antenna calibration for a radio system according to embodiments of the present disclosure.

FIG. 5 illustrates a flowchart of antenna calibration for a radio system according to embodiments of the present disclosure.

FIG. 6 illustrates a schematic view of a first level antenna calibration for a radio system according to embodiments of the present disclosure.

FIG. 7 illustrates a flowchart of a first level antenna calibration for a radio system according to embodiments of the present disclosure.

FIG. 8 illustrates a schematic view of a second level antenna calibration for a radio system according to embodiments of the present disclosure.

FIG. 9 illustrates a flowchart of a second level antenna calibration for a radio system according to embodiments of the present disclosure.

FIG. 10 illustrates a flowchart of a second level antenna calibration for a radio system according to embodiments of the present disclosure.

FIG. 11 illustrates phase difference between antenna elements at t=0 and antenna elements at t=Δt.

FIG. 12 illustrates a flowchart of a second level antenna calibration for a radio system according to embodiments of the present disclosure.

FIG. 13 illustrates a schematic block diagram of a device of antenna calibration for a radio system according to embodiments of the present disclosure.

FIG. 14 schematically illustrates an embodiment of an arrangement which may be used in the device of antenna calibration for a radio system according to embodiments of the present disclosure.

### DETAILED DESCRIPTION

Embodiments herein will be described in detail hereinafter with reference to the accompanying drawings, in which embodiments are shown. These embodiments herein may, however, be embodied in many different forms and should not be construed as being limited to the embodiments set forth herein. The elements of the drawings are not necessarily to scale relative to each other. Like numbers refer to like elements throughout.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood. It will be further understood that terms used herein should be interpreted as having a meaning that is consistent with their meaning in the context of this specification and the relevant art and will not be interpreted in an idealized or overly formal sense unless expressly so defined herein.

The following are some terms that may be involved in this disclosure.

Radio Chain: radio chains may comprise receiver chains, transmitter chains or transceiver chains and/or the filter units, antenna units, subarrays, etc. The receiver chains may comprise Low Noise Amplifiers (LNA), switches, filters, Analog-to-Digital Converters (ADC) etc. The transmitter chains may comprise Power Amplifier (PA), Digital-to-Analog Converters (DAC), switches, filters, etc. The transceiver may comprise clocks, digital units, Field Programmable Gate Arrays (FPGAs), Application Specific Integrated Circuits (ASICs) etc.

Radio Access Node: As used herein, a “radio access node” or “radio network node” is any node in a radio access network of a cellular communications network that operates to wirelessly transmit and/or receive signals. Some examples of a radio access node include, but are not limited to, a radio base station (RBS) (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), and a relay node.

Network Node: As used herein, a “network node” is any node that is either part of the radio access network or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

An AC scheme currently used is to send and receive antenna calibration signals in a certain interval. Antenna calibration signals occupy a traffic slot to perform an AC measurement, i.e., to measure channel response or state or information of radio chains. Then calibration values in the form of coefficients would be calculated according to an AC algorithm and used to compensate the impairment of the radio chain.

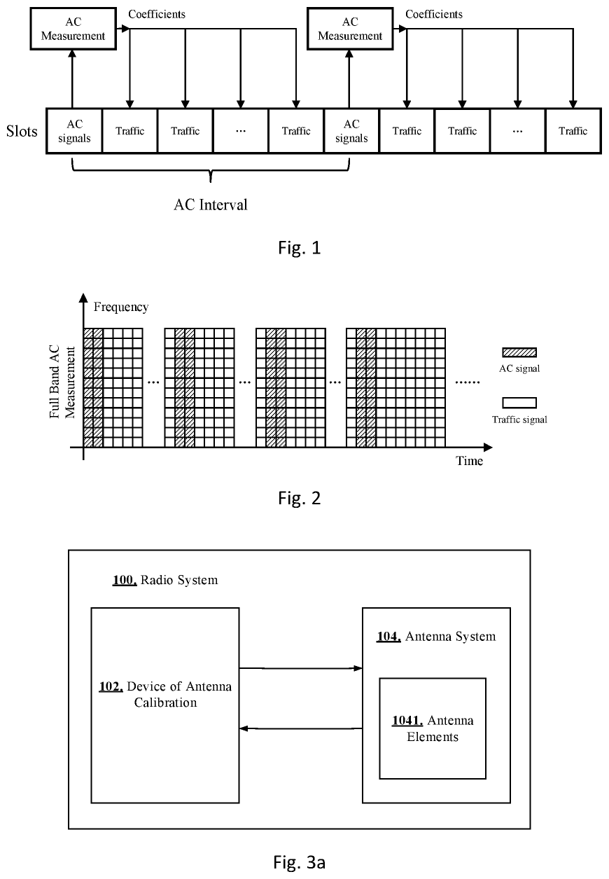

As shown in FIG. 1, the AC measurement would be done once in a period, which is called an AC interval. The coefficients from one AC measurement would be used to compensate the traffic in following multiple slots. In between two adjacent AC measurements, the coefficients would not be updated. To make the coefficients to be more accurate to the actual state of radio chains, a shorter AC interval is needed, especially when in higher and higher frequency band, channel state of radio chains change rapidly. If the AC compensation accuracy and interval cannot keep up with the changes, throughput and MIMO performance of gNB will be severely degraded.

However, the current AC solution has issues such as the followings.

Firstly, tracking of radio chains is also not closely. Variations of radio chain channel state between two AC measurements are unknown, so there is no way to track the radio chain channel state closely. The AC interval can be some hours, or minutes, or seconds on different products. Accordingly, the calibration values are not updated in real time. Some factors that may affect radio chain channel state, like radio frequency power level of the antenna elements, temperatures, etc. change dynamically so that the actual real time radio chain channel state is hard to be acquired.

Secondly, to follow up radio chain variations and improve calibration accuracy, the AC interval should be shortened and more traffic slot occupations will be involved for more AC measurements. As the AC measurements require injection of antenna calibration signals, as shown in FIG. 2, thus it causes more traffic disturbance. For example, in 5G, the Active Antenna System (AAS) of Millimeter Wave (MMW) and highband needs to perform AC measurement once every second (or even at a shorter interval), which however has a great impact on traffic.

Thirdly, each single AC measurement may be disturbed by internal or external factors like noise and interference, so estimation accuracy may not be satisfied.

Embodiments of the present disclosure aim to address one or more of the problems arisen in antenna calibration.

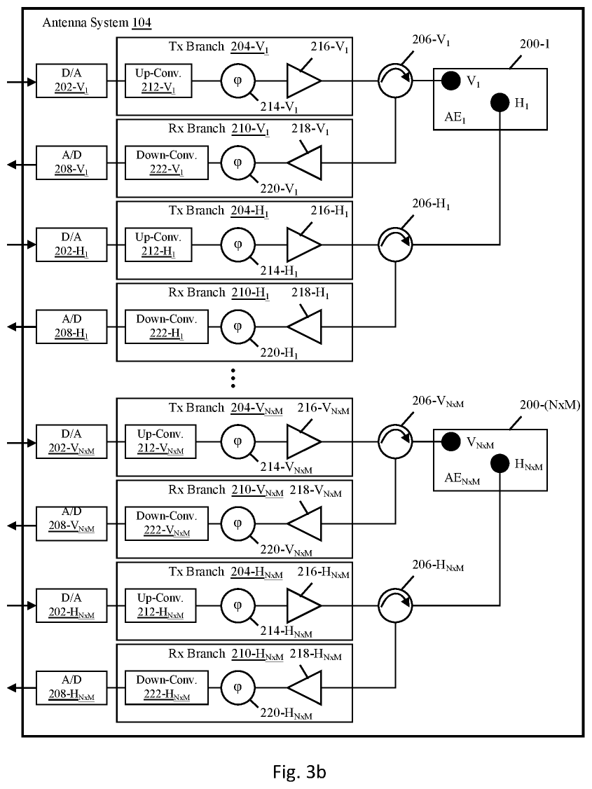

FIG. 3a illustrates an example embodiment of a radio system that applies antenna calibration for an antenna array according to embodiments of the present disclosure.

The radio system 100 is also referred to herein as a beamforming transceiver. The radio system 100 is preferably a radio access node in a cellular communications network (e.g., a base station in a 3GPP 5G NR network). However, the radio system 100 may alternatively be, for example, an access point in a local wireless network (e.g., an access point in a WiFi network), a wireless communication device (e.g., a UE in a 3GPP 5G NR network), or the like. The radio system 100 performs beamforming via an antenna array. This beamforming may be, e.g., analog beamforming, which is performed by controlling gain and phase for each antenna branch via respective gain and phase control elements. However, it should be appreciated that, in some other embodiments, the radio system 100 may perform, e.g., hybrid beamforming, i.e., perform beamforming partly in the digital domain and partly in the analog domain or may perform digital beamforming (i.e., beamforming fully in the digital domain).

As illustrated, the radio system 100 includes an device of antenna calibration 102 and an antenna system 104. The antenna system 104 may be a Phased Antenna Array Module (PAAM). Note that the term “PAAM” is used herein only for reference. Other names may be used. For example, the PAAM may also be referred to herein as an Advanced Antenna System (AAS). In some embodiments, the antenna system 104 is implemented as one or more radio ASICs, and the device of antenna calibration 102 is a baseband processing unit implemented as, e.g., one or more processors such as, e.g., one or more CPUs, one or more baseband ASICs, one or more Field Programmable Gate Arrays (FPGAs), or the like, or any combination thereof.

As discussed below in detail, the antenna system 104 includes an antenna array. The antenna array includes many Antenna Elements (AEs) 1041. The antenna system 104 includes separate transmit branches (also referred to herein as transmit paths) and separate receive branches (also referred to herein as receive paths) for each AE 1041. As an example, each transmit branch includes a gain control element and a phase control element that are controlled by the device of antenna calibration 102 to provide gain and phase calibration between the transmit branches and, in some embodiments, analog beamforming for signals transmitted by the radio system 100. Note that analog calibration and analog beamforming are shown herein as an example; however, the present disclosure is not limited thereto. Likewise, each receive branch includes a gain control element and a phase control element that are controlled by the device of antenna calibration 102 to provide gain and phase calibration between the receive branches, and in some embodiments, analog beamforming for signals received by the radio system 100.

Details of the device of antenna calibration 102 will be described with reference to FIG. 14 below. FIG. 3b illustrates an example of the antenna system of FIG. 3a in accordance with some embodiments of the present disclosure. It is noted that this is only an example architecture of the antenna system design. There may be different architectures for different products and the present invention does not aim to be limited to only one architecture.

As illustrated in FIG. 3b, the antenna system 104 includes AEs 200-1 through 200-(NM), where N×M defines the dimensions of a two-dimensional (2D) matrix of AEs into which the AEs 200-1 through 200-(N×M) are arranged. In some preferred embodiments, N+M>6. The AEs 200-1 through 200-(N×M) are generally referred to herein collectively as AEs 200 and individually as AE 200. In the illustrated example, each AE 200 has two polarizations, namely, a vertical polarization and a horizontal polarization having respective inputs. For example, the AE 200-1 has a first Input/Output (I/O) connection point (Vi) for the vertical polarization and a second I/O connection point (H 1) for the horizontal polarization.

In this example with two polarizations, for the vertical polarization of each i-th AE 200-i (where i=1, 2, . . . , N×M), the antenna system 104 includes a Digital to Analog (D/A) converter 202-Vi and a transmit (Tx) branch 204-Vi coupled to the vertical I/O connection point (Vi) of the AE 200-i via a circulator (filter, duplexer or Rx-Tx switch), 206-Vi for the transmit direction and an Analog to Digital (A/D) converter 208-Vi and a receive (Rx) branch 210-V coupled to the vertical I/O connection point (Vi) of the AE 200-i via the circulator 206-V. The Tx branch 204-V includes up-conversion circuitry 212-V, a phase adjustor, or phase control element, 214-V, and an amplifier, or gain control element, 216-V. While not illustrated, the phase adjustor 214-V and the amplifier 216-V are controlled by the device of antenna calibration 102 to thereby control the gain and phase of the Tx branch 204-V. Similarly, the Rx branch 210-V includes an amplifier, or gain control element, 218-V, a phase adjustor, or phase control element, 220-V, and down-conversion circuitry 222-V. While not illustrated, the amplifier 218-V and the phase adjustor 220-V are controlled by the device of antenna calibration 102 to thereby control the gain and phase of the Rx branch 210-V.

For the horizontal polarization of each i-th AE 200-i (where i=1, 2, N×M), the antenna system 104 includes a D/A converter 202-Hi and a Tx branch 204-Hi coupled to the horizontal I/O connection point (Hi) of the AE 200-i via a circulator, or duplexer, 206-Hi for the transmit direction and an A/D converter 208-Hi and a Rx branch 210-Hi coupled to the horizontal I/O connection point (Hi) of the AE 200-i via the circulator 206-Hi. The Tx branch 204-Hi includes up-conversion circuitry 212-Hi, a phase adjustor, or phase control element, 214-Hi, and an amplifier, or gain control element, 216-Hi. While not illustrated, the phase adjustor 214-Hi and the amplifier 216-Hi are controlled by the device of antenna calibration 102 to thereby control the gain and phase of the Tx branch 204-Hi. Similarly, the Rx branch 210-Hi includes an amplifier, or gain control element, 218-Hi, a phase adjustor, or phase control element, 220-Hi, and down-conversion circuitry 222-Hi. While not illustrated, the amplifier 218-Hi and the phase adjustor 220-Hi are controlled by the device of antenna calibration 102 to thereby control the gain and phase of the Rx branch 210-Hi.

It is noted that when an AE 200-i is configured for Tx (i.e., coupled to the Tx branch 204-Vi and/or the Tx branch 204-Hi), the AE 200-i is referred to herein as a “Tx AE” or “transmit AE”. Conversely, when an AE 200-i is configured for Rx (i.e., coupled to the Rx branch 210-Vi and/or the Rx branch 210-Hi), the AE 200-i is referred to herein as an “Rx AE” or “receive AE”. In FDD, the AE is connected to TX and RX at the same time but separated by frequency.

As discussed above, due to various factors such as radio frequency power level of the antenna elements, temperatures, aging, traffic load, etc. gain and phase may vary between the Tx branches 204 and may also vary between the Rx branches 210. The device of antenna calibration 102 operates to perform a method of antenna calibration by which the radio system 100 calibrates gain and phase between the Tx branches 204-Vi through 204-V_{N×M}, calibrates gain and phase between the Tx branches 204-Hi through 204-H_{N×M}, calibrates gain and phase between the Rx branches 210-Vi through 210-V_{N×M}, and calibrates gain and phase between the Rx branches 210-Hi through 210-H_{N×M}.

In general, the method of antenna calibration obtains a number of measurements and then uses these measurements to determine gain and phase adjustments for the various Tx and Rx branches needed for calibration at the same time by e.g. code division.

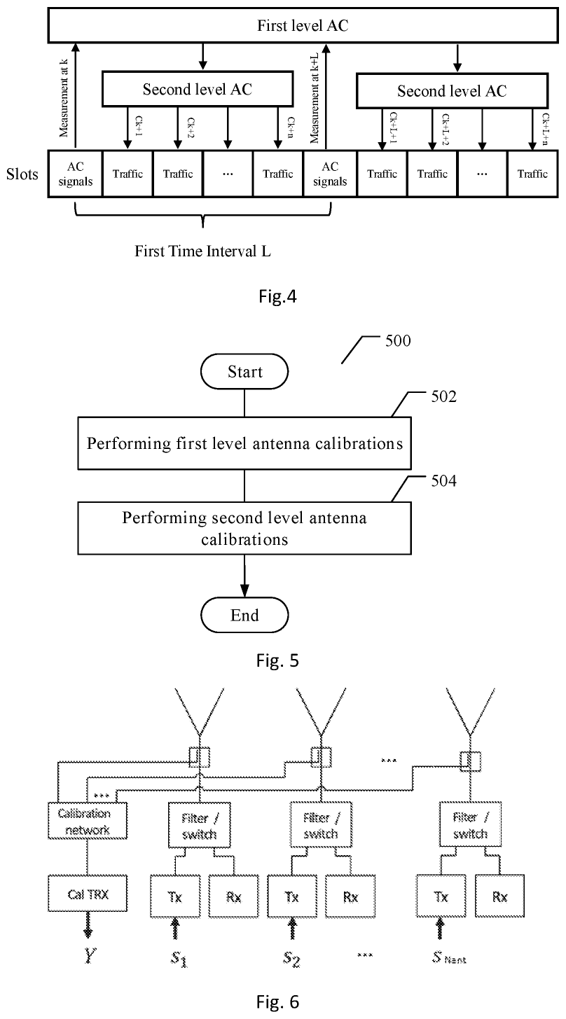

FIG. 4 illustrates a schematic view of antenna calibration for a radio system according to embodiments of the present disclosure, and FIG. 5 illustrates a flowchart of antenna calibration for a radio system according to embodiments of the present disclosure. As can be seen from FIGS. 4 and 5, a two level antenna calibration is applied. The first level antenna calibrations is performed at a first time interval L 502, and the second level antenna calibrations is performed in between the first level antenna calibrations at a second time interval 504, wherein the second level antenna calibrations are based on estimations, and the first time interval L comprises more than one second time intervals. In an example, the second time interval is a slot. Then in this example, the first time interval L may be a length of, if not hundreds, thousands of slots. However, embodiments of the present disclosure are not limited to the granularity of slot, but may also comprise traffic symbol, etc. As shown in FIG. 4, the first level AC is performed on the basis of measurement of the radio chains, at time Tₖ, k+L, . . . , k+nL respectively, wherein n is a positive integer. Accordingly, AC signals are injected once every first time interval L. Result of the first level AC will act as an input to the second level AC to generate calibration values in the form of coefficients Cₖ, Cₖ₊₁ . . . Cₖ₊ₙ, at for example each slot to compensate the traffic.

In this way, the first level AC can address the slow variation of channel state while the second level AC is to address the fast variation of channel state, for example temperature, traffic load, radio frequency power level of the antenna elements, aging of the antenna elements etc. that may affect the radio chain channel state. For highly integrated radio systems, temperature at critical components will change based on traffic load. Critical components cause phase drift versus temperature change.

The second time interval for the prediction is much shorter than the first time interval for the measurements as shown in FIG. 4. Hence there are close tracking on changes of the radio chain channel state and more accurate estimation in the second level AC.

Details of the first level AC and the second level AC will be described with reference to FIGS. 6-11 below.

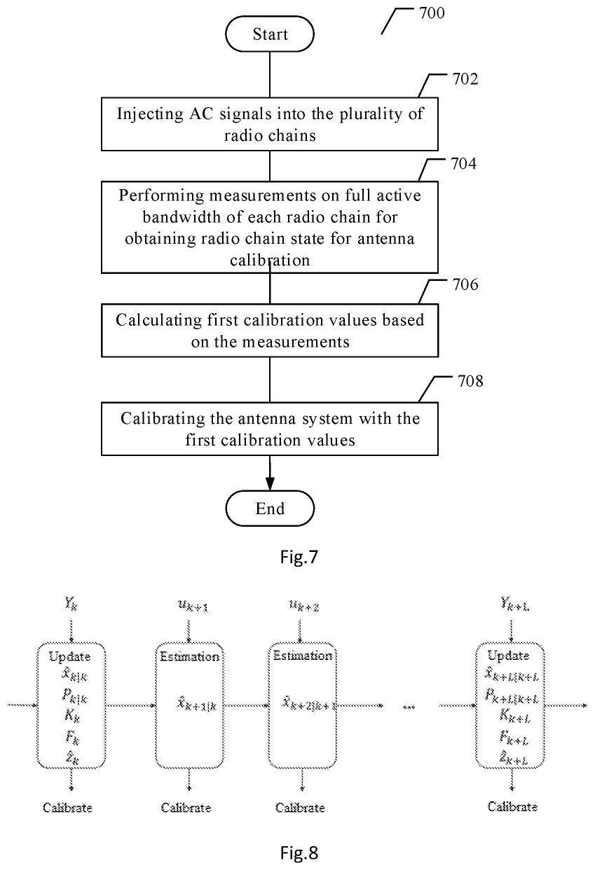

FIG. 6 illustrates a schematic view of a first level antenna calibration for a radio system according to embodiments of the present disclosure, and FIG. 7 illustrates a flowchart of a first level antenna calibration for a radio system according to embodiments of the present disclosure. What is shown in FIG. 6 is a downlink calibration. A skilled person would know that for uplink calibration, an AC signal will be injected into “Cal TRX” (short for calibration transmitter and receiver), and components of Y will be received from each Rx. As shown in FIGS. 6 and 7, measurements on full active bandwidth of each radio chain for obtaining radio chain channel state for antenna calibration is performed at step 704. In downlink calibration, this requires an AC signal S to be injected via transmitters Txs of antenna elements which are controlled by filters or switches therein to function as transmitters Tx or receivers Rx:

$$S = [ {s}_{1} ( n ) , {s}_{2} ( n ) , … {s}_{{N}_{ANT}} ( n ) ] n = 1 , 2 , … , {N}_{sc} , \qquad ( 1 )$$

N_{ANT} is the number of antenna branches (i.e., antenna elements) in a RBS. N_{sc} is the number of subcarriers covered by AC signals. For a typical application, N_{sc} is set to a number to cover the whole carrier frequency band. Accordingly, an output signal Y is received from a calibration network or coupling paths:

$$Y = H \cdot S + V , \qquad ( 2 )$$

H is the actual radio chain channel state, and V is a noise matrix, with

$$Cov \{ {VV}^{*} \} = {σ}_{v}^{2} I , \qquad ( 3 )$$

* is the conjugate transpose operation, Cov represents Covariance, σᵥ is a constant value, and I is an identity matrix.

Then a radio chain channel state from measurements Ĥ (affected by noise) is calculated as:

$$\hat{H} = Y \cdot {S}^{*} = H + V \cdot {S}^{*} , \qquad ( 4 )$$

· is dot product operation.

Here we use ĥ to denote the radio chain channel state of one antenna from measurements, then:

$$\hat{H} = [ {\hat{h}}_{1} ( n ) , {\hat{h}}_{2} ( n ) , … {\hat{h}}_{{N}_{ANT}} ( n ) ] , n = 1 , 2 , … , {N}_{sc} . \qquad ( 5 )$$

Then first calibration values based on the measurements are calculated at step 706 based on radio chain channel state from measurements Ĥ. The first calibration values in an example are in a form of coefficients.

Then the antenna system is calibrated with the first calibration values at step 708.

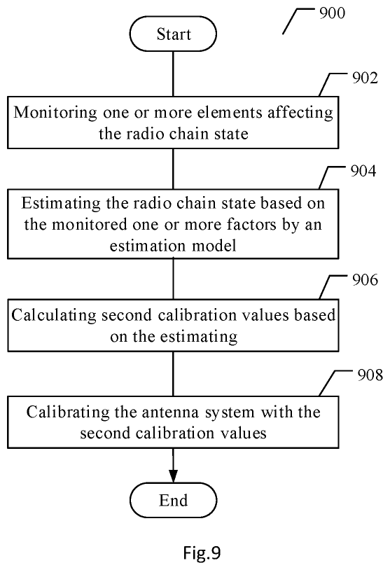

FIG. 8 illustrates a schematic view of a second level antenna calibration for a radio system according to embodiments of the present disclosure, and FIG. 9 illustrates a flowchart of a second level antenna calibration for a radio system according to embodiments of the present disclosure. At step 902, one or more factors affecting the radio chain channel state, such as temperature, radio frequency power level of the antenna elements, etc., are monitored directly. Traffic load may also be monitored, which in turn affects temperature and radio frequency power level of the antenna elements.

Then at step 904, the radio chain channel state based on the monitored one or more factors is estimated by an estimation model. In one embodiment, the estimation model comprises a Kalman Filter model. In this Kalman Filter model, the actual radio chain channel state x of a radio chain is unknown and dynamically changing. For simplification, estimation of only one radio chain is described, and similarity goes to other radio chains. The Kalman filter model assumes that a radio chain channel state vector at time Tₖ₊₁, xₖ₊₁, evolves from an actual radio chain channel state vector at time Tₖ xₖ according to:

$${x}_{k + 1} = {F}_{k + {1}^{X} k} + {B}_{k + 1} {u}_{k} + {q}_{k} , \qquad ( 6 )$$

Where Fₖ₊₁ is a state transition matrix which is applied to the previous radio chain channel state vector xₖ, Bₖ₊₁ is the control-input matrix which is applied to control vector uₖ, qₖ is process noise vector which is assumed to be drawn from a zero mean multivariate Gaussian distribution with covariance matrix Qₖ:

$${Q}_{k} = {σ}_{q}^{2} I , \qquad ( 7 )$$

where σ_{q} is a constant value, and I is an identity matrix.

At time Tₖ a calculated radio chain channel state from measurements ĥₖ of the actual radio chain channel state xₖ is calculated from:

$${\hat{h}}_{k} = {C}_{k} {x}_{k} + {v}_{k} , \qquad ( 8 )$$

where Cₖ is the measurement matrix that maps the actual radio chain channel state xₖ into the calculated radio chain channel state from measurements. vₖ is the measurement noise which is assumed to be a zero mean Gaussian noise with covariance Rₖ. ĥₖ in function (8) is the one in function (5), and then function (8) could be used to calculate xₖ.

As factors impacting the radio chain channel state are chosen as temperature and radio frequency power level of the antenna elements, the control vector u of the Kalman filter model is defined as:

$$u = [ \begin{matrix}{u}_{t} \\ {u}_{p}\end{matrix} ] , \qquad ( 9 )$$

where uₜ is increment of temperature, and up is increment of radio frequency power level of the antenna elements. They can be measured in every second time interval. Measurements of those factors doesn't have traffic disturbance. It is noted that alternatively or additionally, other factors affecting the radio chain channel state such as aging, traffic load, etc. may also be monitored and applied as the control vector.

The radio chain channel state vector x contains three parts:

$$x = [ \begin{matrix}{x}_{c} \\ \dot{{x}_{c}} \\ \ddot{{x}_{c}}\end{matrix} ] , \qquad ( 10 )$$

where x_{c} is the radio chain channel state. \dot{x}_{c} is the 1^{st} derivatives of the radio chain channel state or referred to as channel state drift. \ddot{x}_{c} is the 2^{nd} derivatives of the radio chain channel state or referred to as channel state drift rate.

F is the state transition matrix defined for a time increment of the second level interval, for example, length tₛ, from time Tₖ to time Tₖ₊₁ as below:

$$F = [ \begin{matrix}1 & {t}_{s} & {t}_{s}^{2} / 2 \\ 0 & 1 & {t}_{s} \\ 0 & 0 & 1\end{matrix} ] . \qquad ( 11 )$$

Measurement matrix C and control-input matrix B are defined as below:

$$C = [ \begin{matrix}1 & 0 & 0\end{matrix} ] , \qquad ( 12 )$$

$$B = [ \begin{matrix}α {t}_{s} & β {t}_{s}^{2} / 2 \\ α & β {t}_{s} \\ 0 & 1\end{matrix} ] , \qquad ( 13 )$$

where α and β are constant values which can be measured in manufacturing stage. Obviously, if tₛ remain the same, Fₖ₊₁=Fₖ and Bₖ₊₁=Bₖ.

The model of radio chain channel state is thus calculated as below:

$${[ \begin{matrix}{x}_{c} \\ \dot{{x}_{c}} \\ \ddot{{x}_{c}}\end{matrix} ]}_{k + 1} = {[ \begin{matrix}{x}_{c} + \dot{{x}_{c}} {t}_{s} + \ddot{{x}_{c}} {t}_{s}^{2} / 2 \\ \dot{{x}_{c}} + \ddot{{x}_{c}} {t}_{s} \\ \ddot{{x}_{c}}\end{matrix} ]}_{k} + {[ \begin{matrix}α {t}_{s} {u}_{t} + β {t}_{s}^{2} {u}_{p} / 2 \\ α {u}_{t} + β {t}_{s} {u}_{p} \\ {u}_{p}\end{matrix} ]}_{k} . \qquad ( 14 )$$

This is an ideal function for calculating radio chain channel state vector at time Tₖ₊₁ from the radio chain channel state vector at time Tₖ. However, the actual radio chain channel state vector at time Tₖ is generally not known. An estimated radio chain channel state vector \hat{x} at time Tₖ is used instead for calculating radio chain channel state vector at time Tₖ₊₁. Then the function is rewritten as:

$${\hat{x}}_{k + 1 \vert k} = {F}_{k + 1} {\hat{x}}_{k} + {B}_{k + 1} {u}_{k} + {q}_{k} , \qquad ( 15 )$$

where \hat{x}_{k+1|k} denotes the calculated radio chain channel state at time Tₖ₊₁ given observations at time Tₖ. \hat{x}ₖ denotes the estimated radio chain channel state vector at time Tₖ, qₖ is the vector of process noise.

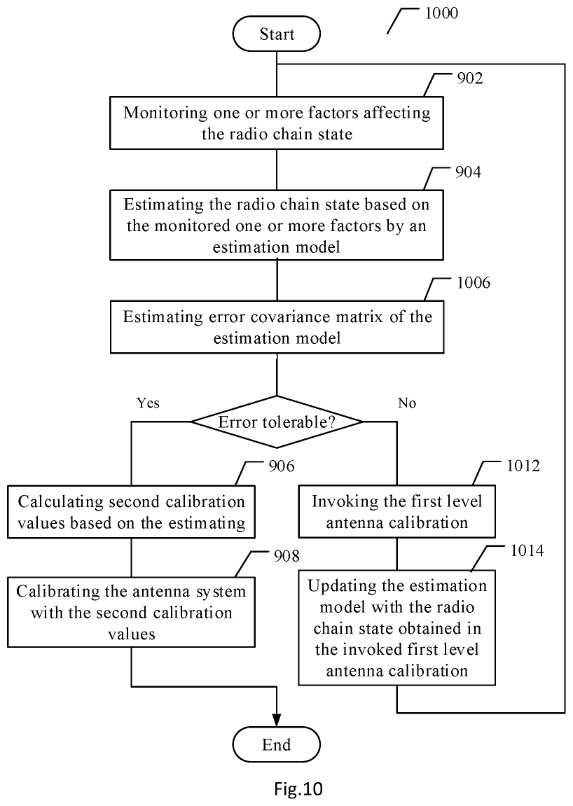

Meanwhile, in one embodiment, referring to FIG. 10, at step 1006, an estimated error covariance matrix at time Tₖ₊₁ given information of time Tₖ, P_{k+1|k} can be calculated as:

$${P}_{k + 1 \vert k} = {F}_{k + 1} {P}_{k} {F}_{k + 1}^{T} + {Q}_{k} , \qquad ( 16 )$$

Pₖ is the estimated error covariance matrix at time Tₖ. Qₖ is covariance matrix of the process noise vector qₖ as described above, and

$${P}_{k + 1 \vert k} = {[ \begin{matrix}{P}_{cc} & {P}_{ct} & {P}_{cp} \\ {P}_{tc} & {P}_{tt} & {P}_{tp} \\ {P}_{pc} & {P}_{pt} & {P}_{pp}\end{matrix} ]}_{k + 1 \vert k} , \qquad ( 17 )$$

wherein P_{cc} refers to correlation of radio chain channel state, P_{ct} and P_{tc} refer to correlation between radio chain channel state and temperature and are of the same value, P_{cp} and P_{pc} refer to correlation between radio chain channel state and power level and are of the same value, Pₜₚ and Pₚₜ refers to correlation between temperature and power level and are of the same value. Pₜₜ refers to correlation of temperature, Pₚₚ refers to correlation of power level.

If the variance of components of the radio chain channel state vector is not known initially, the P matrix is initialized with suitably large numbers on the main diagonal (i.e., P_{cc}, Pₜₜ, Pₚₚ). The suitably large number is determined by experience. All elements of the P matrix which are not on the main diagonal are initialized with 0.

A Kalman filter, as known by a skilled person, is a recursive estimator which has two phases: a predicting phase and an update phase. The above has described the predicting phase which uses the radio chain channel state of a previous time to provide an estimate of current time. Although Tₖ₊₁ and Tₖ are used to indicate two adjacent predicts, however, the present disclosure does not aim to be limited to predicting the radio chain channel state of current time from a previous adjacent one, but may from another previous one as appropriate.

The second calibration values, for example in the form of coefficients, may be calculated from the radio chain channel state of current time at step 906 and then at step 908, the antenna system 104 may be calibrated with the second calibration values.

The radio chain channel state from measurements Ĥ is not needed during the prediction phase, while in the update phase, the radio chain channel state from measurements Ĥ are used to update parameters of the estimation model to refine the predict.

Now we discuss the update phase of the Kalman filter. The update phase of the Kalman filter may be triggered due to error intolerance or the first time interval expiration. Once the estimated error covariance matrix is obtained, a determination with regard to whether the error covariance matrix is tolerable may be made. In practical application, the Frobenius norm of P matrix can be used to make the determination:

$${‖ P ‖}_{F} = \sqrt{{\sum }_{j = 1}^{m} ( {\sum }_{i = 1}^{n} {\vert {P}_{ij} \vert}^{2} )} , \qquad ( 18 )$$

where m and n are the number of columns and rows of P matrix.

In response to determining that the P matrix is not tolerable, the first level antenna calibration may be invoked at step 1012 to update at step 1014 the Kalman filter model with the radio chain channel state obtained in the invoked first level antenna calibration, before next second level antenna calibration. Otherwise, the process may proceed to step 906 and then 908.

Once every first time interval expires, new measurements will be performed for a new first level antenna calibration, and parameters of the Kalman filter model will be updated with the radio chain channel state obtained in the new first level antenna calibration.

parameters of the Kalman filter model are updated as follows:

$${\hat{z}}_{k + L} = {\hat{h}}_{k + L} - {C}_{k + L} {\hat{x}}_{k + L \vert k + L - 1} , \qquad ( 19 )$$

$${K}_{k + L} = {P}_{k + L \vert k + L - 1} {{C}_{k + L}^{T} ( {C}_{k + L} {P}_{k + L \vert k + L - 1} {C}_{k + L}^{T} + {R}_{k + L} )}^{- 1} , \qquad ( 20 )$$

$${\hat{x}}_{k + L \vert k + L} = {\hat{x}}_{k + L \vert k + L - 1} + {K}_{k + L} {\hat{z}}_{k + L} , \qquad ( 21 )$$

$${P}_{k + L \vert k + L} = ( I - {K}_{k + L} {C}_{k + L} ) {P}_{k + L \vert k + L - 1} , \qquad ( 22 )$$

where L is the second time interval. \hat{z}_{k+L} is the residual error between radio chain channel state from measurements and that from estimate. F_{k+L} is the optimal Kalman gain. \hat{x}_{k+L|k+L} is the updated radio chain channel state which would be used during the predicting phase. P_{k+L|k+L} is updated estimate covariance which would be used during the predicting phase. I is the identity matrix.

The updated parameter above could be used to perform the next predicting of the second level AC. Meanwhile, the updated radio chain channel state \hat{x}_{k+L|k+L} could be used for current AC.

Therefore, as shown in FIG. 8, output signals Yₖ, Y_{k+L} . . . Y_{k+nL} received from the calibration network or coupling paths shown in FIG. 6 at time k, k+L, . . . k+nL are used to update parameters of the Kalman filter model as listed in functions (19)-(22). Additional or alternatively, the length L may be varied for example around the initial radio chain channel state, and upon the estimated error covariance matrix is not tolerable. Between two adjacent updates, in one embodiment, a Kalman filter model is applied to for the second level AC, where radio chain channel state \hat{x}_{k+1|k}, \hat{x}_{k+2|k+1}, . . . \hat{x}_{k+L|k+L-1} are estimated.

In an initial state of the radio system 100, there will be a measurement, and radio chain channel state \hat{x} and the matrix P shall be initialized with a suitable value. In one embodiment, the first time interval L is initially short to make the algorithm converge quickly, and then a longer first time interval L is set. That is to say, the first time interval L could be varied as time goes by. The second time interval may also be varied during the second level antenna calibrations.

Due to the update regularly or in response to estimated error covariance matrix being not tolerable, accuracy of the second level AC may be improved. With the Kalman filter model, factors that affect radio chain channel state such as temperature, traffic load, radio frequency power level of the antenna system may be involved for more accurate and refined radio chain channel state estimation. As the Kalman filter model uses the radio chain channel state of a previous time to provide an estimate of current time, impact from abrupt noise and interference may be mitigated. As hardware is also a source of internal interference due to fault, resilience to hardware disruption may be enhanced accordingly.

As measurements with AC signals are only performed at the first time interval which could be much longer than the second time interval, disturbance to the traffic could be reduced and measurement accuracy could be enhanced. In the second level ACs, antenna calibration could be at a granularity of a slot or a traffic symbol, without taking extra measurements. Therefore, close tracking of actual radio chain channel state is enabled. As the second level AC does not require much computation, the calibration method may bring high antenna calibration at low system computation cost.

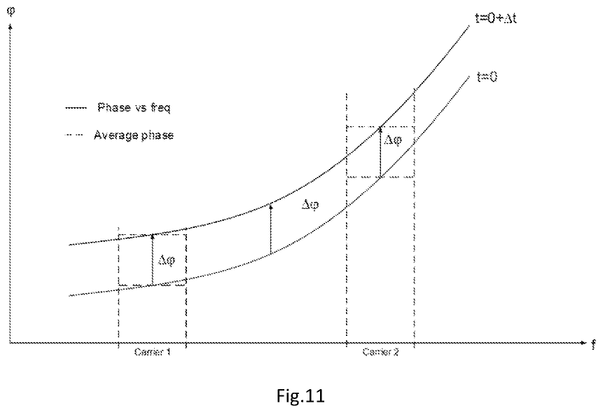

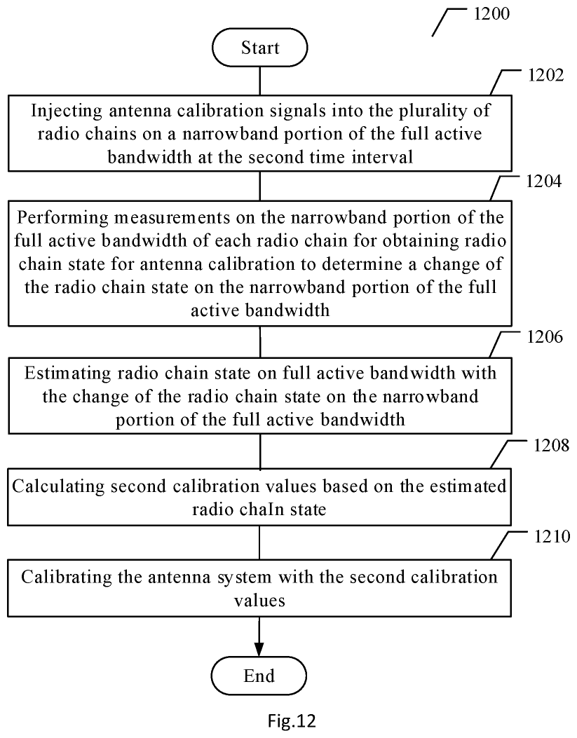

FIG. 11 illustrates phase difference between antenna elements at t=0 and antenna elements at t=Δt, and FIG. 12 illustrates a flowchart of a second level antenna calibration for a radio system according to embodiments of the present disclosure.

The majority of the differential phase drift between antenna branches is due to changes in the reference clock distribution and up-conversion from clock to Radio Frequency (RF). This up-conversion can be done in an RF Local Oscillator (LO) component, or in RF DAC/ADC 202/208. If the operating Bandwidth (BW) of the radio system 100 is much smaller than the RF carrier frequency, the phase drift from the above mentioned effects can be seen as constant across the whole BW, or possibly with a small slope across the BW.

In today's product we support around 200 MHz BW, at carrier frequencies above 2 GHz. The relative BW is thus below 10% which can be considered to be small. This implies that the phase drift observed in a small part of the BW can be applied to the full BW for AC.

For the first level AC, functions (1)-(5) as discussed above are applied. But for the second level AC, though measurements are also applied, they are performed only on a narrowband portion of full active bandwidth of each radio chain for obtaining radio chain channel state for antenna calibration to determine a change of the radio chain channel state on the narrowband portion of the full active bandwidth at step 1204, then as phase drift from the above mentioned effects can be seen as constant across the whole BW, or possibly with a small slope across the BW, radio chain channel state on several subcarriers, if not full active bandwidth, may be estimated at step 1206 based on the change of the radio chain channel state on the narrowband portion of the full active bandwidth. This narrowband portion of the full active bandwidth can be chosen as any one or more single subcarriers in the full active bandwidth, for example the first subcarrier, or the one with the minimum impact on traffic, and can be varied among different second level ACs according to the traffic. In this regard, before step 1204, at step 1202, AC signals are injected into each radio chain on the narrowband portion of the full active bandwidth at the second time interval.

Afterwards, at step 1208, second calibration values are calculated based on the estimated radio chain channel state from step 1206 and are used to calibrate the antenna system at step 1210.

In one example, the phase drift from time t=0 to time t=0+Δt is basically a constant Δφ at subcarriers including subcarrier 1 and subcarrier 2, as shown in FIG. 11. In this case, radio chain channel state on the whole BW at time t=0+Δt could be estimated based on the radio chain channel state on the chosen narrowband portion of the full active bandwidth at time t=0 and the constant Δφ without or with very little loss of accuracy, which indicated in a function is:

$$( n ) = {H}_{first} ( n ) \cdot ( {H}_{second} ( 1 ) \cdot {H}_{first}^{*} ( 1 ) ) , \qquad ( 23 )$$

$$Where {H}_{first} ( n ) = [ {\hat{h}}_{1} ( n ) , {\hat{h}}_{2} ( n ) , … {\hat{h}}_{{N}_{ANT}} ( n ) ] , n = 1 , 2 , … , {N}_{sc} , \qquad ( 24 )$$

as obtained in function (5)

$${H}_{first} ( 1 ) = [ {\hat{h}}_{1} ( 1 ) , {\hat{h}}_{2} ( 1 ) , … {\hat{h}}_{{N}_{ANT}} ( 1 ) ] , \qquad ( 25 )$$

where * means the conjugate operation, · means the dot production, the first subcarrier is chosen as the narrowband portion of the full active bandwidth, and Δφ can be known from H_{second}(1)·H_{first}*(1).

It is noted that H_{first}*(1) may be intrinsically already included in H_{second}(1), when the second level AC is done after the first level AC is applied. In such a case dot production with H_{first}*(1) is not needed and function (23) is simplified as:

$$( n ) = {H}_{first} ( n ) \cdot {H}_{second} ( 1 ) .$$

This embodiment may provide a balance between disturbance to the traffic and calibration accuracy from measurements.

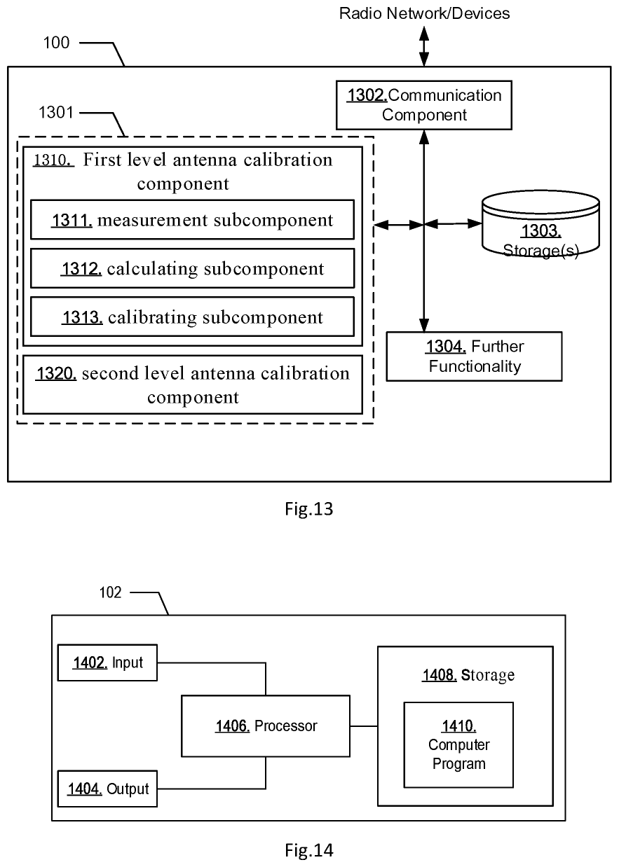

FIG. 13 illustrates a schematic block diagram of a radio system according to embodiments of the present disclosure.

The part of radio system 100 which is most affected by the adaptation of the herein described method, e.g., a part of the method 500, 700, 900, 1000 and 1200, is illustrated as an arrangement 1301, surrounded by a dashed line. The radio system 100 and arrangement 1301 may be further configured to communicate with other network entities (NE) e.g. the radio network via a communication component 1302 internal or external (now shown) to the radio system 100. The communication component 1302 comprises means for radio communication or wireless communication, such as the antenna system 104. The arrangement 1301 or radio system 100 may further comprise a further functionality 1304, such as functional components providing regular user equipment functions, regular Base Station functions, or functions of any other radio communication device, and may further comprise one or more storage(s) 1303.

The arrangement 1301 could be implemented, e.g., by one or more of: a processor or a microprocessor and adequate software and memory for storing of the software, a Programmable Logic Device (PLD) or other electronic component (s) or processing circuitry configured to perform the actions described above, and illustrated, e.g., in FIGS. 5, 7, 9, 10 and 12. The arrangement 1301 of the radio system 100 may be implemented and/or described as follows.

Referring to FIG. 13, the radio system 100 is configured with antenna calibration function, comprising, alternatively or additionally, or comprising all of, but enabling, any one or more of the following components a first level antenna calibration component 1310 configured to perform first level antenna calibrations at a first time interval, and a second level antenna calibration component 1320 configured to perform second level antenna calibrations in between the first level antenna calibrations at a second time interval, wherein the second level antenna calibrations are based on estimations, and length of the first time interval is of more than one length of second time intervals. The first level antenna calibration component 1310 further comprises a measurement subcomponent 1311, a calculating subcomponent 1312, and a calibrating subcomponent 1313. The measurement subcomponent 1311 is configured to perform measurements of full active bandwidth of each radio chain for obtaining radio chain channel state for antenna calibration, the calculating subcomponent 1312 is configured to calculate first calibration values based on the measurements, and the calibrating subcomponent 1313 is configured to calibrate the antenna system with the first calibration values.

It should be noted that the two different components or subcomponents in this disclosure may be logically or physically combined.

FIG. 14 schematically illustrates an embodiment of an arrangement which may be used in the device of antenna calibration for a radio system according to embodiments of the present disclosure. Comprised in the arrangement 102 are here a processor 1406, e.g., with a Digital Signal Processor (DSP). The processor 1406 may be a single unit or a plurality of units to perform different actions of procedures described herein. The arrangement 102 may also comprise an input unit 1402 for receiving signals from other entities, and an output unit 1404 for providing signal(s) to other entities. The input unit and the output unit may be arranged as an integrated entity or as illustrated in the example of FIG. 14.

Furthermore, the arrangement 102 comprises at least one computer program product 1408 in the form of a non-volatile or volatile memory, e.g., an Electrically Erasable Programmable Read-Only Memory (EEPROM), a flash memory and a hard drive. The computer program product 1408 comprises a computer program 1410, which comprises code/computer readable instructions, which when executed by the processor 1406 in the arrangement 102 causes the arrangement 102 and/or the device in which it is comprised to perform the actions, e.g., of the procedure described earlier in conjunction with FIGS. 3, 5 and/or 7.

The computer program 1410 may be configured as a computer program code structured in computer program modules. Hence, in an exemplifying embodiment when the arrangement 102 is used in the radio system 100, the code in the computer program of the arrangement 102 when executed, will cause the processor 1406 to perform the steps as described with reference to FIGS. 5, 7, 9, 10, and/or 12.

The processor 1406 may be a single Central Processing Unit (CPU), but could also comprise two or more processing units. For example, the processor 1406 may include general purpose microprocessors, instruction set processors and/or related chip sets and/or special purpose microprocessors such as ASICs. The processor 1406 may also comprise board memory for caching purposes. The computer program 1410 may be carried by a computer program product 1408 connected to the processor 1406. The computer program product may comprise a computer readable medium on which the computer program is stored. For example, the computer program product may be a flash memory, a Random-access memory (RAM), a Read-Only Memory (ROM), or an EEPROM, and the computer program modules described above could in alternative embodiments be distributed on different computer program products in the form of memories. The computer program product may also comprise an electronic signal, optical signal, or radio signal, etc. in which the computer program is transmitted.

The arrangement 102 can be a base station, sometimes also referred to in the art as a Base Transceiver Station (BTS), a macro base station, a node B, or B-node, an eNodeB (eNB), a gNodeB (gNB), etc, and is sometimes also referred to in the art as a micro/femto/pico base stations, a micro/femto/pico node B, or micro/femto/pico B-node, a micro/femto/pico eNodeB (eNB), etc. Besides, the arrangement 102 could also be any other device in the wireless network, such as a WLAN access point, etc.

The arrangement 102 may also be a user equipment (UE). UEs may be served by cells and the numbers served by different cells need not to be identical. The term “UE” used herein may indicate all forms of devices enabled to communicate via a communication network, such as mobile telephones (“cellular” telephones) and laptops with mobile termination, and thus can be, for example, portable, pocket, hand-held devices, such as mobile phones, smart phones, personal digital assistants (PDA); computer-included devices, such as desktops, laptops; vehicles, or other devices, such as meters, household appliances, medical appliances, multimedia devices, automobile-mounted devices, etc., which communicate voice and/or data via radio access network.

As a whole or by scenarios, as measurements with AC signals are only performed at the first time interval which could be much longer than the second time interval, disturbance to the traffic could be reduced and measurement accuracy could be enhanced and thus MIMO performance of RBS can be enhanced. In the second level ACs, antenna calibration could be updated at second time interval which could be at a granularity of a slot or a traffic symbol, without taking extra measurements. Therefore, close tracking of actual radio chain channel state is enabled. As the second level AC does not require much computation, the calibration method may bring high antenna calibration at low system computation cost. With the Kalman filter model, due to the update regularly or in response to estimated error covariance matrix being not tolerable, accuracy of the second level AC may be further improved. factors that affect radio chain channel state such as temperature, traffic load, radio frequency power level of the antenna system may be involved for more accurate and refined radio chain channel state estimation. As the Kalman filter model uses the radio chain channel state of a previous time to provide an estimate of current time, impact from abrupt noise and interference may be mitigated.

While the embodiments have been illustrated and described herein, it will be understood by those skilled in the art that various changes and modifications may be made, and equivalents may be substituted for elements thereof without departing from the true scope of the present technology. In addition, many modifications may be made to adapt to a particular situation and the teaching herein without departing from its central scope. Therefore it is intended that the present embodiments not be limited to the particular embodiment disclosed as the best mode contemplated for carrying out the present technology, but that the present embodiments include all embodiments falling within the scope of the appended claims.

1.-25. (canceled)

26. A method of antenna calibration for a radio system comprising an antenna system, wherein the antenna system comprises a plurality of antenna elements corresponding to a plurality of radio chains, the method comprising:
performing first level antenna calibrations at a first time interval, wherein each first level antenna calibration comprises:
performing measurements of full active bandwidth of each radio chain for obtaining radio chain channel state;
calculating first calibration values based on the measurements; and
calibrating the antenna system with the first calibration values; and
performing second level antenna calibrations in between the first level antenna calibrations at a second time interval, wherein the second level antenna calibrations are based on estimations, and wherein a length of the first time interval is of more than one length of second time intervals.

27. The method of claim 26, wherein performing each of the second level antenna calibrations comprises:
monitoring one or more factors affecting the radio chain channel state;
estimating the radio chain channel state based on the monitored one or more factors by an estimation model;
calculating second calibration values based on the estimating; and
calibrating the antenna system with the second calibration values.

28. The method of claim 27, wherein the radio chain channel state obtained in the first level antenna calibrations is used to update parameters of the estimation model at the first time interval.

29. The method of claim 27, wherein the monitored one or more factors comprise any one or more of the following: temperature, component aging, traffic load, or radio frequency power level of the antenna elements.

30. The method of claim 27, wherein the estimation model estimates current radio chain channel state based on the monitored one or more factors and a previous estimated radio chain channel state.

31. The method of claim 30, wherein the radio chain channel state obtained in the first level antenna calibrations is used to update the previous estimated radio chain channel state at the first time interval.

32. The method of claim 27, wherein the estimation model comprises a Kalman Filter model.

33. The method of claim 32, wherein the Kalman Filter model comprises the following functions:
$${x}_{k + 1} = {F}_{k + 1} {x}_{k} + {B}_{k + 1} {u}_{k} + {q}_{k} , \\ F = [ \begin{matrix}1 & {t}_{s} & {t}_{s}^{2} / 2 \\ 0 & 1 & {t}_{s} \\ 0 & 0 & 1\end{matrix} ] , \\ B = [ \begin{matrix}α {t}_{s} & β {t}_{s}^{2} / 2 \\ α & β {t}_{s} \\ 0 & 1\end{matrix} ] , \\ x = [ \begin{matrix}{x}_{c} \\ \dot{{x}_{c}} \\ \ddot{{x}_{c}}\end{matrix} ] , \\ u = [ \begin{matrix}{u}_{t} \\ {u}_{p}\end{matrix} ] ,$$
where subscript k denotes time Tₖ, subscript k+1 denotes time Tₖ₊₁, x_{k+1|k} denotes the radio chain state at time Tₖ₊₁ given observations at time Tₖ. xₖ denotes the radio chain state vector at time Tₖ, tₛ is time length from time Tₖ to time Tₖ₊₁, α and β are constant values which are measurable in manufacturing stage, x_{c} is the radio chain channel state, \dot{x}_{c} is the 1^{st} derivatives of the radio chain channel state, \ddot{x}_{c} is the 2^{nd} derivatives of the radio chain channel state, uₜ is increment of temperature, and uₚ is increment of radio frequency power level of the antenna elements, qₖ is a process noise vector at time Tₖ, which is assumed to be drawn from a zero mean multivariate Gaussian distribution with covariance matrix Qₖ:
Qₖ=σ_{q}²I,
where σ_{q} is a constant value, and I is an identity matrix.

34. The method of claim 32, wherein performing each of the second level antenna calibrations further comprises:
estimating an error covariance matrix of the estimation model; and
in response to determining that the error covariance matrix is not tolerable, invoking the first level antenna calibration, and updating parameters of the estimation model with the radio chain channel state obtained in the invoked first level antenna calibration, before a next second level antenna calibration.

35. The method of claim 26, wherein performing each of the second level antenna calibrations comprises:
injecting antenna calibration signals into the plurality of radio chains on a narrowband portion of the full active bandwidth at the second time interval;
performing measurements on the narrowband portion of the full active bandwidth of each radio chain for obtaining radio chain channel state for antenna calibration to determine a change of the radio chain channel state on the narrowband portion of the full active bandwidth;
estimating radio chain channel state on full active bandwidth with the change of the radio chain channel state on the narrowband portion of the full active bandwidth;
calculating second calibration values based on the estimated radio chain channel state; and
calibrating the antenna system with the second calibration values.

36. The method of claim 35, wherein the narrowband portion of the full active bandwidth comprises one or more subcarriers of the full active bandwidth.

37. The method of claim 35, wherein the narrowband portion of the full active bandwidth is varied for different second level antenna calibrations according to the traffic load.

38. The method of claim 26, wherein the first time interval varies among the first level antenna calibrations, and/or the second time interval varies among the second level antenna calibrations.

39. The method of claim 26, wherein the first time interval at an initial stage is shorter than the first time interval at a subsequent stage.

40. The method of claim 27, wherein performing each of the first level antenna calibrations further comprises injecting antenna calibration signals into the plurality of radio chains at the first time interval.

41. The method of claim 26, wherein the second time interval is at a granularity of a slot or a traffic symbol.

42. An apparatus of antenna calibration for a radio system comprising an antenna system, wherein the antenna system comprises a plurality of antenna elements corresponding to a plurality of radio chains, wherein the apparatus comprises processing circuitry configured to:
perform first level antenna calibrations at a first time interval, wherein each first level antenna calibration comprises:
performing measurements of full active bandwidth of each radio chain for obtaining radio chain channel state;
calculating first calibration values based on the measurements; and
calibrating the antenna system with the first calibration values; and
perform second level antenna calibrations in between the first level antenna calibrations at a second time interval, wherein the second level antenna calibrations are based on estimations, and wherein a length of the first time interval is of more than one length of second time intervals.

43. A radio system comprising:
an antenna system comprising a plurality of antenna elements corresponding to a plurality of radio chains; and
an apparatus of antenna calibration, wherein the apparatus comprises processing circuitry configured to:
perform first level antenna calibrations at a first time interval, wherein each first level antenna calibration comprises:
performing measurements of full active bandwidth of each radio chain for obtaining radio chain channel state;
calculating first calibration values based on the measurements; and
calibrating the antenna system with the first calibration values; and
perform second level antenna calibrations in between the first level antenna calibrations at a second time interval, wherein the second level antenna calibrations are based on estimations, and wherein a length of the first time interval is of more than one length of second time intervals.
